(19) United States
(12) Patent Application Publication
(10) Pub. No.: US 2012/0245972 A1
(43) Pub. Date: Sep. 27, 2012

(54) PROVIDING ACCESS TO FUTURE EXCEPTION INFORMATION IN A SUPPLY PLAN COLLABORATION SYSTEM

(75) Inventors: Thomas Sorgie, New York, NY (US); Mark W. Unger, Forest Hills, NY (US)

(73) Assignee: TradeCard Inc., New York, NY (US)

(21) Appl. No.: 13/072,651

(22) Filed: Mar. 25, 2011

(51) Int. Cl. G06Q 10/00

(52) U.S. Cl. 705/7.28

(57) ABSTRACT

A supply plan collaboration system tracks supply plans and, based upon status information received from users of the system, identifies future exceptions that will arise due to the status information, in the absence of further changes to the supply plan. Future exceptions may be tracked by the system, provided to users before or at the time that they occur, and closed or otherwise managed by the system as they become relevant or are removed by further changes related to the supply plan.

### BACKGROUND

Supply chain and other similar collaboration systems allow suppliers and buyers to coordinate transactions within a supply chain. Such systems allow for more efficient fulfillment of purchasing and manufacturing orders. For example, participants in a supply chain collaboration system may match demand levels to orders for goods, without having to maintain excess inventory to insure that the known demand is met.

In some systems, buyers may send advanced notices of expected demand to suppliers, who may then respond with an indication of available supply, availability date, etc. The supplier and buyer then establish a supply plan that sets out the order and delivery parameters for the desired goods. Typically, supply plan information is produced from a buyer's planning system. This data is then pushed to suppliers, who can provide comments on potential issues with the buyer's plan. This type of process can result in data loss, miscommunication, and delayed planning

Some systems may transfer responsibility for various portions of supply chain planning between buyers and suppliers. For example, a buyer may be made responsible for providing updates to partner suppliers regarding expected demand for raw materials or other products. Such configurations allow the supplier to indicate how they would match the expected buyer needs.

### BRIEF SUMMARY

Embodiments described herein relate generally to the identification and management of exception, and especially “future exceptions” as described below, within a supply plan. A supply plan collaboration system may track supply plans and, based upon status information received from users of the system, identify future exceptions that will arise due to the status information, in the absence of further changes to the supply plan. Future exceptions may be tracked by the system, provided to users before or at the time that they occur, and closed or otherwise managed by the system as they become relevant or are removed by further changes related to the supply plan.

In an embodiment, a technique for managing exceptions in a supply management system may include first storing data regarding the status of a plurality of components in a supply plan being tracked by the system. The components may be, for example, fulfillment rates supplied by suppliers such as suppliers, planned rates provided by buyers, and the like. A status of one of the components may be received, after which one or more possible exceptions arising due to the status of the first component may be determined. The status may be received from any participant in the system, including buyers and suppliers. Each exception may identify a supply state that results in a portion of the supply plan not being completed unless the exception is corrected. Each determined possible exception may be identified as either a future exception that will arise at a future time only in the absence of a further status change that removes the exception, or as a present exception that exists at the time the status is received. For each future exception, the system may store a time at which the future exception will occur and provide an indication of at least one existing future exception to a user. The future exceptions may be raised to one or more users at or before the time at which they are to occur, and may be provided in response to user requests, such as for exception reports, status reports, and the like. The system may provide only a single future exception, a group of future exceptions, such as all exceptions of a particular type, or a comprehensive list of all known future exceptions.

In an embodiment, a method for managing future exceptions in a supply chain collaboration system includes receiving, from a first user, status information for a component of a supply plan in the supply chain collaboration system and, based upon the status information, identifying each potential exception within a supply plan that includes the component. The status may be received from any participant in the system, including buyers and suppliers. For each potential exception, the system may determine whether the exception will only occur in the future and only in the absence of a further status change to the supply plan and subsequently identify the exception as a future exception and store a time at which the exception will occur. The system also may raise one or more future exceptions to a user of the supply chain collaboration system before or at the stored time the exception will occur. The components may be, for example, fulfillment rates supplied by suppliers such as suppliers, planned rates provided by buyers, and the like. The future exceptions may be raised to one or more users at or before the time at which they are to occur, and may be provided in response to user requests, such as for exception reports, status reports, and the like. The system may provide only a single future exception, a group of future exceptions, such as all exceptions of a particular type, or a comprehensive list of all known future exceptions.

A system according to an embodiment may include a computer-readable storage medium storing data regarding the status of a plurality of components in a supply plan being tracked by the system; a communication subsystem configured to receive a status of a first component of the plurality of components; and a processor. The processor may determine at least a possible exception arising due to the status of the first component, and, for each determined possible exception, identify the exception as either a future exception that will arise at a future time only in the absence of a further status change that removes the exception, or as a present exception that exists at the time the status is received. The processor also may store a time at which each future exception will occur, and provide an indication of at least one existing future exception to a user. The future exceptions may be raised to one or more users at or before the time at which they are to occur, and may be provided in response to user requests, such as for exception reports, status reports, and the like. The system may provide only a single future exception, a group of future exceptions, such as all exceptions of a particular type, or a comprehensive list of all known future exceptions.

A system according to an embodiment may include a communication subsystem configured to communicate with one or more users of the system and to receiving, from a first user of the one or more users, status information for a component of a supply plan in the supply chain collaboration system. The system may include a processor configured to identify each potential exception within a supply plan that includes the component. Based upon the status information, the system may determine whether the exception will only occur in the future and only in the absence of a further status change to the supply plan and, upon so determining, identifying the exception as a future exception and storing a first time at which it will occur. One or more future exceptions may be raised to a user of the supply chain collaboration system no later than the first time. The future exceptions may be raised to one or more users at or before the time at which they are to occur, and may be provided in response to user requests, such as for exception reports, status reports, and the like. The system may provide only a single future exception, a group of future exceptions, such as all exceptions of a particular type, or a comprehensive list of all known future exceptions.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example system suitable for use with various embodiments.

FIG. 2 shows an example schematic of a simple supply plan.

FIG. 3 shows an example basic process for managing future exceptions according to an embodiment.

FIG. 4 shows a detailed process for managing future exceptions according to an embodiment.

### DETAILED DESCRIPTION

It has been found that conventional supply planning systems do not provide efficient techniques for reliable data transfer between participants, and for reliable updating of known data at each participant. For example, expected orders, demand changes, inventory levels, component characteristics, and other data are often communicated between buyers, suppliers, and other partners by way of data files transmitted between them, such as spreadsheets, emails, and the like. These techniques greatly increase the chance that data known to the participants will become unsynchronized or otherwise inaccurate, leading to errors in the supply chain and, ultimately, to failures to provide agreed-upon goods or services.

It has also been found that conventional collaboration systems do not provide participants with sufficient visibility into other participants' data to allow for efficient planning For example, a buyer may provide the supplier with their expected forecast and the supplier's production schedule may not meet the forecast. However, the buyer may have no visibility into the supplier's scheduled production. As another example, a buyer may not immediately become aware of a specific known delay, conflict, or other condition that can delay or otherwise affect supplier's production schedule. In many cases, the buyer may only become aware of such a condition after receiving notice of the late shipment of goods from the supplier, which can result in a significant delay from the time the condition occurs. Similarly, some conventional collaboration systems allow for a periodic “dump” of a supply plan to provide updates to participants in the plan. Due to the scale and number of items involved, the updates may be relatively far apart and may include entire plans, rather than just relevant update information.

These shortcomings of conventional systems may be further complicated by the scale and structure often required by collaboration systems. For example, a supply plan collaboration system according to embodiments disclosed herein may need to track tens of millions of items or more, each of which may be updated weekly, daily, or more often or at unpredictable intervals. Supply plan components may not be logically grouped, such as occurs with a purchase order or invoice, because each item is tracked and updated independently. At typical scales, a user may wish to access information on thousands of items at a time, which, to provide useful information, must also be correlated with any related items out of the tens of millions of items tracked by the system. The scales involved can also preclude the use of conventional item tracking techniques. For example, an item-based approach to tracking and resolving exceptions within a supply plan may work for a relatively simple plan, but be computationally difficult when dealing with thousands or millions of components.

Embodiments of the invention provide supply plan collaboration systems and techniques that allow participants in the system to have a greater visibility of an entire supply plan, including portions that are handled by other entities associated with the plan. In particular, participants may be notified or be able to access known exceptions within the plan, including exceptions that are expected to occur in the future absent further changes to plan components. Users may receive or access supply plan and exception data in real time or near real time.

Embodiments as disclosed herein may enable all parties to a supply plan to have up-to-date knowledge of potential delays, excess and other exceptions in the supply chain procurement process as early as possible. Most exceptions arise as a matter of comparing fulfillment rates (which typically are supplier provided) to plan expectations (typically buyer provided). Exception rules may be defined by a comparison of relevant data, in combination with a time (e.g., a date and/or specific time) at which point if the exception becomes a problem that may preclude completion of the supply plan. For example, being behind by 1000 units within 10 days of an expected ship date may be an exception. Similarly, it may be possible to determine that, unless additional changes occur, a plan will be 1000 units behind at the expected ship date. Such a condition may be referred to as a “future exception.” A future exception may be removed, such as where a further update to the status of supply plan components obviates the future exception. For example, an inventory update or change in planned delivery of an upstream component may show that the plan will no longer be 1000 units behind at the ship date, thus removing the future exception.

As described above, in conventional solutions the information flow is one-directional by way of electronic documents, typically generated at most weekly, so little visibility to exceptions has previously been available to planners.

In general, embodiments may calculate all exceptions that arise within a supply plan whenever a component is updated, and store the results of this analysis. This may allow a user of the system to be provided with a list of all current exceptions for any particular component relatively quickly. For example, a user may enter an update to a component, and immediately be presented with a list of exceptions in the supply plan that the component update causes. As another example, a user may request and receive a list of all currently-known exceptions within a supply plan, with an indication of the component or component update that caused each exception.

In some configurations, the process of identifying any present exceptions caused by a component update may not provide a complete or comprehensive indication of all exceptions that may result from the update. For example, exceptions may arise due to a lack of an item update as opposed to a received update. As a specific example, it may be acceptable for a component to be under-fulfilled 15 days before shipment, but if the component remains under-fulfilled at 10 days before shipment, then an exception should be risen. Exception rules may be explicitly defined within a supply planning system as disclosed herein. For example, a rule may be defined that products of a given style must be ready to ship within a particular time, such as 10 days, of an expected shipment date. The system also may define various escalation rules, such as (for the previous example) to provide a warning at day 15, a normal priority error at day 10, and a critical alarm at day 5. In general, any exception rules may be defined, which then may be used to identify and raise exceptions.

To address this and other shortcomings of conventional supply plan collaboration systems, embodiments described herein allow the exception system to “see into the future” by recording every potential exception for an item each time it is updated, even if it will only occur at some future time and only in the absence of further changes to components of the supply plan. For exceptions that will happen in the future if nothing changes, the exception may be marked as a future problem or “future exception,” with a time and/or date at which the exception should be risen. If the situation is repaired before the expected time, then the exception may be removed by the system without further action from a user; e.g., the exception can “disappear” quietly with unconcerned users never knowing it was a potential problem. Embodiments also may provide users insight into potential problems before they would be raised to their trading partners, thus enabling them to provide better service.

As used herein, an “exception” refers to identifying a state that results in a portion of a supply plan not meeting expectations absent a subsequent change of state that corrects the condition. Similarly, a “future exception” refers to an exception that does not presently exist, but that will arise at a future time in the absence of a further status change that removes the exception. In some configurations, system and techniques as disclosed herein may categorize exceptions as “past exceptions” (which have been corrected), “present exceptions” (which are currently an issue), and/or “future exceptions” (which are expected, but have not yet occurred).

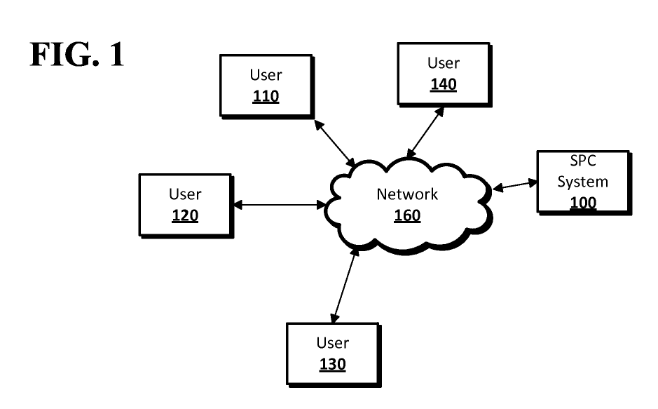

FIG. 1 shows an example system suitable for use with various embodiments. One or more user participants 110-140 may be in communication with a supply plan collaboration (SPC) system 100 via a network 160 or other communication means. The users 110-150 may be buyers, retailers, suppliers, raw materials or component suppliers, manufacturers, and the like. More generally, each user of the system may be a buyer, a supplier, or both a buyer and a supplier in different contexts, though typically a particular entity is only a buyer or a supplier within a given supply plan. Within a given supply plan, a buyer receives goods or services from a supplier, typically in exchange for payment to the supplier. A single user may be both a buyer and a supplier in different contexts within the system, depending on the user's relationship to a transaction and one or more other users.

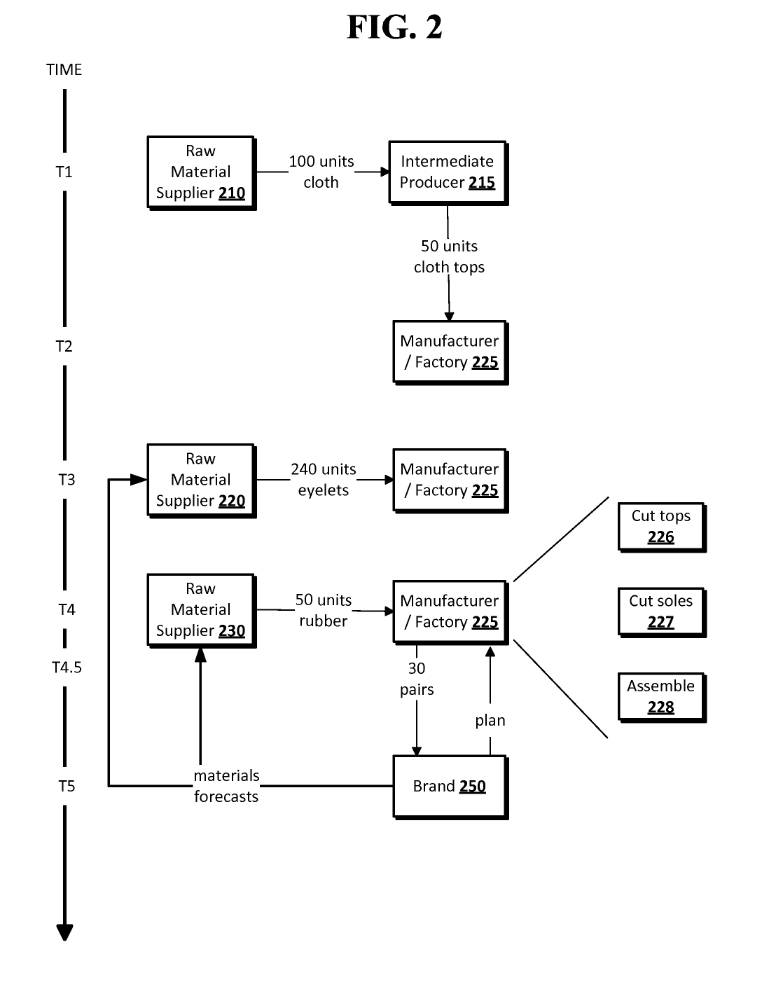

FIG. 2 shows a schematic of a simple example supply plan for producing shoes and providing them to a brand 250. In the example, each entity 210, 215, 220, 225, 230, 250 may be a user of a supply plan collaboration system that tracks the illustrated supply plan. In each of the illustrated transactions, the recipient of goods or services may be considered a “buyer,” and the provider of the goods or services the “supplier” as described elsewhere herein.

According to the example plan, at a first time Ti a raw material supplier 210 is scheduled to provide 100 units of cloth to an intermediate producer 215. The intermediate producer 215 is scheduled to provide 50 cloth tops to a manufacturer or specific factory 225 at a time T2. Similarly, at a later time T3 a raw material supplier 220 is scheduled to provide 240 units of eyelets to the manufacturer 225, and at a later time T4 another raw material supplier 230 is scheduled to provide 50 units of rubber to the fabrication plant 225. It will be understood that the specific arrangement and relative times of the materials supplied to the manufacturer 225 are illustrative only. For example, other supply plans may specify that each of the eyelets and rubber units should be supplied to the manufacturer 225 within a specific time frame, or that the rubber should be supplied at a time earlier than the eyelets. Similarly, the timing of various procedures performed at the manufacturer may depend upon one or more of the materials receive from the suppliers 220, 230.

The fabrication plant 225 may perform a process to fabricate shoes from the received materials including, for example, cutting the tops 226, cutting the soles 227, and assembling the final show 228. The process may be scheduled to occur within a time period T4, or it may have more specific scheduling requirements, such as the steps 226, 227, 228 being scheduled for times T4.1, T4.2, and T4.3 (not shown). It will be understood that in general a manufacturer or other participant in a supply plan may perform multiple processes, and/or much more complex processes than those shown. Various steps of these processes may depend upon actions being completed by other participants in the system, and/or upon other steps being completed by the manufacturer or other participant.

The fabrication plant 225 may be scheduled to deliver a final product to the brand 250, such as 30 completed pairs of shoes, at or by a time T5. As shown, the brand 250 may provide materials forecasts to suppliers, such as raw material suppliers 220, 230. The brand also may provide a plan for shoes to the manufacturer 225 that provides the completed shoes to the brand 250.

Exceptions and/or future exceptions may be identified or may occur at any point in the plan. For example, the raw material supplier 230 may provide an updated status indicating that only 40 units of rubber will be available at T4, and 10 units will be available at a later time T4.5. This may result in one or more future exceptions being identified, such as that the fabrication plant 225 will not be able to provide 30 pairs at time T5. This information may be available to any of the user entities; for example, the manufacturer/factory 225, one or more shippers (not shown), or any other participant in the system may receive a notification of the exception, which would then indicate that their respective shipments may be reduced in quantity or delayed. As another example, the supplier 220 may indicate that the 240 eyelets will not be available at time T3. Another raw material supplier 230 may receive notification of a future exception indicating that the manufacturer 225 will not be able to complete the fabrication process 226-228. This may provide an opportunity for the supplier 230, for example to offer to provide the missing units, and/or to request a corresponding delay in providing the required 50 units of rubber. In general, the system may provide information about any future exception to any participant within the system, or to any participant involved in a particular supply plan.

Exceptions also may occur in or result from a part of the plan that takes place within an entity. For example, the fabrication plant 225 may provide information to indicate that the assembly step 228 will be delayed, which can raise future exceptions for the subsequent transactions.

It will be apparent to one of skill in the art that the supply plan illustrated in FIG. 2 is an overly-simplified example for ease of explanation, and that supply plans according to embodiments disclosed herein may include a large number of participants, transactions, components, and schedules. In general, a future exception may be identified and raised any time a change in a supply plan indicates that at a future time a portion of the supply plan will not being completed as scheduled in the absence of a further status change.

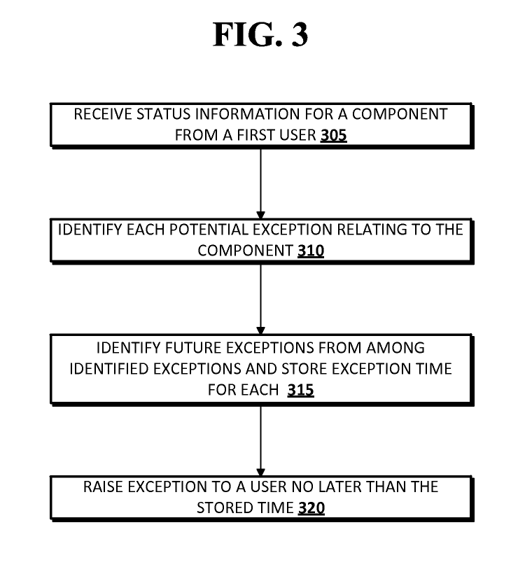

FIG. 3 shows an example basic process for managing future exceptions according to an embodiment. At 305, status information for a component of a supply plan in a supply chain collaboration system may be received from a first user. The status information may be, for example, an expected delivery date, an inventory level, a modified order, or any other information related to a component of the supply plan. Typical components of supply plans include forecasted quantities, commitment quantities, production scheduled quantities, ordered quantities, order dates, delivery dates, shipment dates, and the like, for either finished goods or raw materials, or any other item or data entry tracked by the system for a supply plan. The user may be a buyer, a supplier, or any participant user in the system. Based upon the received status information, the system may identify each potential exception within the supply plan of which the component is a part at 310. For example, a purchase order with quantities of 100 units may be received by the system against a forecasted quantity of 200, 20 days before the expected shipment date on the plan. The plan may require that the quantity must be 160 no later than 10 days prior to the shipment date. In this case there is no current exception, only the potential of a future exception. If, for example, 15 days prior to shipment date, the order quantity now equals 170 units, the future exception goes away.

As another example, a common occurrence that can result in one or more future exceptions within a supply plan is where a supplier or raw materials supplier is expected to have produced a certain quantity of goods by a given number of days N in advance of a future dependency. The future dependency can be, for example, further manufacturing (in the case of raw materials), finished goods shipment, or others. When the supply is a certain level, for example greater than 10%, below planned levels at a particular time, such as N−10 days ahead, a present exception may be raised. The particular time frame N−10 may be chosen to be a time frame that still allows for correction. For the same condition, future exceptions for days N−8 and N−5 may be scheduled for increasing severity should the current situation remain unchanged. If production levels increase in the intervening days, the later future exceptions may never be raised. For example, a user looking only at “present” warnings/exceptions may never see the future exceptions.

Notably, the system does not only identify those exceptions that exist at the time the information is received. For example, a delay of 3 days does not raise an exception based on the current status of all other components of the supply plan, but the system may determine that if the delay still exists at a future time, such as when a subsequent shipment is due, an exception should be raised at that point. Thus, the identified potential exceptions may include exceptions that will exist at a point in the future if no further status updates or other changes within the supply plan remove the exception. To track such exceptions, at 315 the system may determine whether each identified exception will only occur in the future and only in the absence of a further status change to the supply plan. If so, the exception may be identified as a “future exception.” The time at which the future exception will occur, barring further changes that obviate the future exception, may be stored by the system and associated with the particular future exception.

Stored future exceptions may be raised to an appropriate user, such as one that can address the exception, that has requested information about the exception or a type of exception, or that is otherwise associated with the supply plan. The exception may be raised at the stored time that is associated with the exception, i.e., at the time that the exception occurs, or it may be raised at any time before then.

In an embodiment, the system may provide a list of some or all existing future exceptions to a user, such as upon receiving a request from a user for all existing exceptions and/or all existing future exceptions associated with a supply plan. The exceptions may be provided based upon a component with which they are associated, or based upon the supply plan in which they occur.

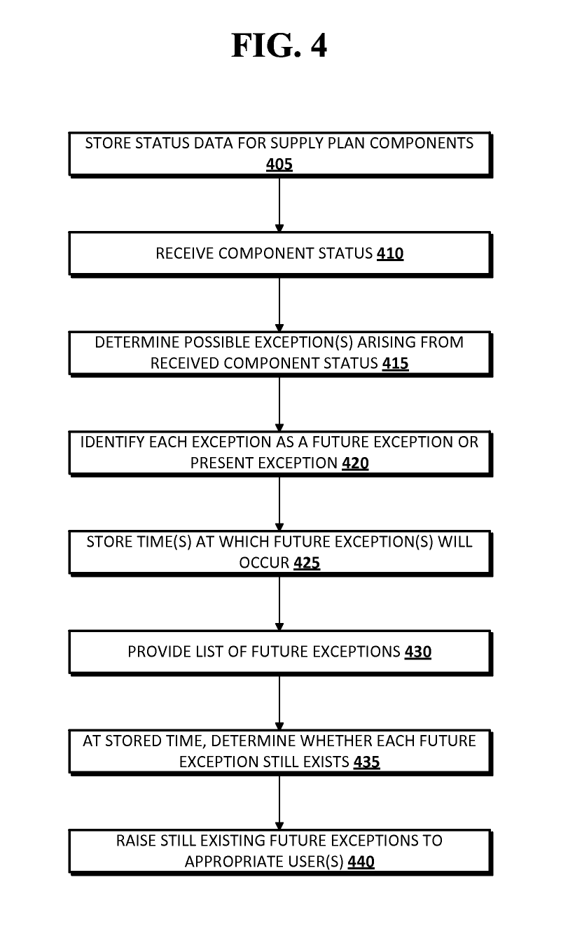

FIG. 4 shows a detailed process for managing future exceptions according to an embodiment. At 405, a supply plan collaboration system may store status data for supply plan components for one or more supply plans. As previously described, each supply plan may be associated with multiple user participants and multiple components within the collaboration system. The system may receive a new or updated component status at 410, such as based upon information from a user of the system. At 415, one or more possible exceptions arising from the status of the component may be determined by the system.

At 420, each possible exception may be identified as either a future exception, which will arise at a future time in the absence of a further status change that removes the exception, or as a present exception that exists when the status information is received. Each future exception may have a specific time, such as a time and/or a date, at which the exception will occur. At 425, the system may store this time for each future exception, with a link or other connection to an identifier of the exception.

The stored exceptions may be provided to users at various times and in various forms. For example, at 430 a list of one or more future exceptions may be provided, such as in response to a request from a user. Any requested or appropriate set of future exceptions and/or present exceptions may be provided. For example, all future exceptions associated with a particular component, occurring within a particular time period, and/or occurring within a particular supply plan may be provided to a user. Users also may be notified of future exceptions when they occur or before they occur, so that the appropriate users are aware of the exceptions and/or can take appropriate steps to remove or mitigate the exceptions. In some configurations, the system may determine whether a future exception still exists at a point before the future exception will occur and, if so, may notify a user about the future exception at 435-440.

In some configurations, embodiments may allow for “handling” of future exceptions with little or no additional business logic or processing. That is, instead of providing additional mechanisms for users to address future exceptions by changing item status and the like, the system may automatically move future exceptions to present exceptions at the appropriate time. The present exceptions then may be raised to users as would be conventional present exceptions (those not originating as future exceptions), for handling as appropriate. Changes made to source components after the original status that resulted in the future exception may eliminate the future exception before it is able to become a present exception. Thus, no additional processing is required to handle future exceptions once they are established.

Various embodiments may deviate from the illustrative structures described herein. For example, the components and modules described may be combined or further split functionally from the specific structures described. Each of the components may be implemented as a software module or a module that combines software and hardware, and multiple illustrated modules may be combined into a single physical or logical module. Generally, any number of functions may be embodied in any number of modules.

The systems and techniques described herein may be implemented on or by any combination of server and client devices. For example, the supply plan collaboration system may be implemented on one or more servers, which may communicate to one or more user devices. Each user device may be one or more client devices, server devices, or any combination thereof. In general, each user may have an independent system that may include one or more clients and/or servers, which as a whole communicates with the supply plan collaboration system. Any known communication and network topology may be used, and any portion of the systems described herein may be implemented locally or in a remote configuration.

Various embodiments may include or be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the present invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A method comprising:
in a supply planning collaboration system, storing data regarding the status of a plurality of components in a supply plan being tracked by the system;
receiving a status of a first component of the plurality of components;
determining at least a possible exception arising due to the status of the first component, each exception identifying a supply state that results in a portion of the supply plan not meeting expectations unless corrected;
for each determined possible exception, identifying the exception as either a future exception that will arise at a future time only in the absence of a further status change that removes the exception, or as a present exception that exists at the time the status is received;
for each future exception, storing a time at which the future exception will occur; and
providing an indication of at least one existing future exception to a user.

2. A method as recited in claim 1, further comprising:
for each stored future exception, no later than the stored time at which the future exception is to occur, determining whether the exception still exists; and
upon determining that a future exception still exists at the stored time, raising the future exception to a user.

3. A method as recited in claim 1, wherein the first component is a fulfillment rate supplied by a supplier.

4. A method as recited in claim 1, wherein the first component is a plan rate provided by a buyer.

5. A method as recited in claim 1, wherein the step of providing the indication of the at least one future exception to the user is performed in response to a request received from the user.

6. A method as recited in claim 1, wherein the step of providing the indication of the at least one future exception to the user further comprises:
providing a list of all existing future exceptions associated with a component in the supply plan to the user.

7. A method as recited in claim 1, wherein the status of the first component is received from a supplier, and wherein the user is a buyer.

8. A method as recited in claim 1, wherein the status of the first component is received from a buyer, and wherein the user is a supplier.

9. A method comprising, within a supply planning collaboration system:
receiving, from a first user, status information for a component of a supply plan in the supply chain collaboration system;
based upon the status information , identifying each potential exception within a supply plan that includes the component;
for each potential exception, determining whether the exception will only occur in the future and only in the absence of a further status change to the supply plan and, upon so determining, identifying the exception as a future exception and storing a first time at which it will occur; and
for at least one future exception, raising the exception to a user of the supply chain collaboration system no later than the first time.

10. A method as recited in claim 9, wherein the component is a fulfillment rate supplied by a supplier.

11. A method as recited in claim 9, wherein the component is a plan rate provided by a buyer.

12. A method as recited in claim 9, further comprising the step of:
providing a list of all existing future exceptions associated with a component in the supply plan to a second user.

13. A method as recited in claim 9, wherein the second user is different than the first user.

14. A method as recited in claim 9, wherein the status information is received from a supplier, and wherein the user is a buyer.

15. A method as recited in claim 9, wherein the status information is received from a buyer, and wherein the user is a supplier.

16. A system comprising:
a computer-readable storage medium storing data regarding the status of a plurality of components in a supply plan being tracked by the system;
a communication subsystem configured to receive a status of a first component of the plurality of components; and
a processor configured to:
determine at least a possible exception arising due to the status of the first component, each exception identifying a supply state that results in a portion of the supply plan not meeting expectations unless corrected;
for each determined possible exception, identify the exception as either a future exception that will arise at a future time only in the absence of a further status change that removes the exception, or as a present exception that exists at the time the status is received; and
for each future exception, store a time at which the future exception will occur; and
provide an indication of at least one existing future exception to a user.

17. A system comprising:
a communication subsystem configured to communicate with one or more users of the system and to receiving, from a first user of the one or more users, status information for a component of a supply plan in the supply chain collaboration system; and
a processor configured to:
based upon the status information, identify each potential exception within a supply plan that includes the component;
for each potential exception, determine whether the exception will only occur in the future and only in the absence of a further status change to the supply plan and, upon so determining, identifying the exception as a future exception and storing a first time at which it will occur; and
for at least one future exception, raise the exception to a user of the supply chain collaboration system no later than the first time.
